(19) United States
(12) Patent Application Publication
(10) Pub. No.: US 2019/0274346 A1
(43) Pub. Date: Sep. 12, 2019

(54) WHITE IRON FOOD ADDITIVE

(71) Applicant: Höganäs AB (Publ), Höganäs (SE)

(72) Inventors: Avinash Gore, Johnstown, PA (US); Sunil Badwe, Export, PA (US)

(73) Assignee: Höganäs AB (Publ), Höganäs (SE)

(21) Appl. No.: 16/338,190

(22) PCT Filed: Sep. 27, 2017
(86) PCT No.: PCT/US2017/053605

§ 371 Date: Mar. 29, 2019

Related U.S. Application Data
(60) Provisional application No. 62/403,412, filed on Oct. 3, 2016.

(51) Int. Cl. A23L 33/16; A23P 10/40; A23P 20/10

(52) U.S. Cl. CPC A23L 33/16; A23P 10/40; A23P 20/10; A23V 2002/00; B22F 1/0062; A23V 2200/254; A23V 2250/1592; A23V 2250/1634; A23V 2250/02; A23V 2200/22

(57) ABSTRACT

A coated iron powder including a core of precursor iron powder, wherein the iron powder is reduced or electrolytic iron powder; a first coating including a first polymer and a first pigment, wherein the coating has a thickness of thickness of 5 to 30 μm; a coating of an adjuvant, wherein the adjuvant includes ascorbic acid; and a second coating including a second polymer and a second pigment, wherein the coating has a thickness of thickness of 5 to 30 μm.

### TECHNICAL FIELD

The present specification concerns food fortification. More specifically, the present specification concerns a coated iron powder which is suitable as food and/or feed additive.

### BACKGROUND

It is well known that iron is an essential dietary ingredient for human wellbeing. Iron deficiency is a major health problem worldwide both in industrialized and non-industrialized societies. In its most severe stage, iron deficiency can cause Anemia. Most of the iron in human body is present as hemoglobin in blood, to carry oxygen from lungs to the tissues.

Many foods are enriched with iron for its nutritional value. Current fortification methods use iron compounds as an iron source. Elemental iron is used in foods where discoloration by iron oxide does not affect the final food properties like color, smell, etc., or the storage or cooking vessels used to store or prepare the final food. Foods like bread and biscuits are fortified by adding iron in the wheat flour; a standard practice across the world.

However foods like rice, white noodles, milk and yoghurt, and also taste-makers like salt are currently not fortified with iron. That is because of absence of iron particles that do not spoil the color, taste or smell during cooking process. Today, commonly used supplemental iron sources are organic iron compounds such as iron gluconate and iron fumarate or inorganic compounds such as iron sulphate. Elemental iron is also used for food enrichment, such as hydrogen reduced iron, electrolytic iron and carbonyl iron. However, the use of elemental iron is limited to the dark color foods such as wheat flour and cereals. A vast majority of food types are light in color, are processed before consumption, and are a significant part of a regular diet of large populations across the world. Elemental iron, if used as-is in these types of foods pose certain problems. One such problem is oxidation, wherein iron reacts with water, oxidizes spoiling the food, and/or staining storage and cooking vessels.

Light colored food is enriched with iron on few occasions with ferrous sulfate. But this is not very common. For example, table salt is hygroscopic in nature and absorbs moisture. Known iron compounds, if used to fortify salt, will decompose in presence of water and release free iron which in turn will oxidize and discolor.

An important feature for the iron containing compounds used as food additive is the bioavailability of the iron, i.e., how efficiently the iron is absorbed by the body. However, iron compounds provide insufficient bioavailability of iron, while elemental iron is readily absorbed. A problem in the art is the inability to provide a sufficiently high level of bioavailability of iron, while also providing an iron that does not oxidize during storage and/or cooking of food.

An attempt at providing an iron with improved bioavailability is disclosed in Indian Patent No. 198399. IN198399 generically relates to using various iron compounds as fortifying agents. For example, IN198399 describes procedure to attempt to improve bioavailability of iron compounds using a battery of organic and inorganic chemicals. Many of these have various side effects on humans. However, these are thought to be necessary to provide sufficient bioavailability. For example, IN198399 at some places mentions elemental iron as micronized iron. The micronized iron is iron ground to finer sizes <10 micron to increase the surface area available. However, the micronized iron is not in a proper ionic state for absorption by human digestive system. To resolve this problem, IN198399 further describes chelating the micronized iron with chelating agent(s) to make it soluble. Thus, IN198399 fails to provide a sufficiently high level of bioavailability of iron that can also avoid oxidizing during storage and/or food preparation.

Some or all of challenges like shelf life, impact of cooking processes, color, taste and smell problems are resolved by embodiments of the present specification.

### SUMMARY

An embodiment of the present specification relates to a coated iron powder comprising a core of precursor iron powder, wherein the iron powder is reduced or electrolytic iron powder; a first coating comprising a first polymer and a first pigment, wherein the coating has a thickness of thickness of 5 to 30 μm, preferably 5 to 25 μm, or preferably 8 to 15 μm; a coating of an adjuvant, wherein the adjuvant comprises ascorbic acid; and a second coating comprising a second polymer and a second pigment, wherein the coating has a thickness of thickness of 5 to 30 μm, preferably 5 to 25 μm, or preferably 8 to 15 μm.

In embodiments, the first pigment and the second pigment may comprise TiO₂. The first coating may prevent the adjuvant from reacting with the iron powder prior to human consumption.

In embodiments, the first polymer and the second polymer may be the same, or the first polymer and the second polymer may be different. For example, the first polymer may be configured for application with an aqueous solvent, and the second polymer may be configured for application with a non-aqueous solvent. The first polymer may comprise hydroxypropylmethylcellulose. The second polymer may comprise dimethylaminoethyl methacrylate.

In embodiments, the precursor iron powder may have a size D50 of 10-53 microns, preferably 15-53 microns, preferably 15-25 microns. The coated iron particle may have iron content from 10-50 wt %, preferably 20-50 wt %, or 30-50 wt %, based on the total weight of the coated iron particles.

In embodiments, a combination of the first coating, the adjuvant coating, and the second coating may be configured to dissolve in gastric acid in less than 600 seconds, preferably less than 60 seconds, preferably less than 10 seconds. The second coating may be configured to dissolve in gastric acid in less than 600 seconds, preferably less than 60 seconds, preferably less than 10 seconds. The first pigment may be included in an amount of 5 to 50 wt %, preferably 10 to 40 wt %, with regard to the total weight of the first coating. The second pigment may be included in an amount of 5 to 50 wt %, preferably 10 to 40 wt %, with regard to the total weight of the second coating. The coating of adjuvant may have a thickness of less than 1 μm, preferably less than 500 nm, preferably less than 300 nm.

In embodiments, the coated iron powder may be able to withstand boiling in water at 100-121° C. at 1-2 atm for a period of at least 10 minutes, preferably at least 20 minutes, at least 30 minutes or at least 45 minutes without showing any signs of degradation. The coated iron powder may be able to withstand pasteurization with heating and cooling cycles between 70° C. and 4° C. for a period of at least 20 minutes, preferably at least 10 minutes, without showing any signs of degradation. The coated iron powder may be able to withstand exposure to a relative humidity of 60% at a temperature of 25° C. for a period of at least 100 days, preferably at least 300 days, without showing any signs of degradation.

In embodiments, the precursor iron powder may have a particle size distribution (D10) in the range of 10 to 20 μm, a particle size distribution (D50) in the range of 15 to 30 μm, and a particle size distribution (D90) in the range of 40 to 70 μm. The precursor iron powder may have an average surface area in the range of 0.2 to 0.5 m2/g and average apparent density of 0.8 to 3 g/cm3.

### BRIEF DESCRIPTION OF FIGURES

FIG. 1 shows a flow chart of an exemplary spray drying process. In this process, the slurry is prepared by adding iron powder, pigment (TiO₂/Talc) and binder (polymer) in solvent (aqueous/non aqueous). This mixture is then mixed with high shear mixing so that all the components are suspended in the slurry. The slurry viscosity is adjusted for easy atomization in the spray dryer. The rotation of atomizer is then set to achieve proper droplets. The droplets then fall through a temperature gradient in the drying chamber. The dried powder is then collected at the bottom.

FIG. 2 shows a flow chart for an exemplary fluid bed drying process. In this process unlike spray drying, slurry is made of solvent, binder and pigment. Iron powder is accelerated in the fluidizing chamber using Wurster Column. Due to this the powder attains vertical circular motion. The slurry is then sprayed either from top or from bottom on to the powder stream. Since the iron powder particles are in circular motion, they get uniformly coated with slurry. The temperature gradient in the chamber is maintained so that the coating on the powder is dried by the time the powder reaches the bottom. The dried powder is collected from the bottom.

FIG. 3 shows SEM image and EDS of a coated iron particle. Image shows uniform charging of the particle indicating uniform coating material. EDS shows peaks of Ti, O, Mg, Al and Si indicating presence of TiO₂ and Talc. Absence of Fe peak confirms that the coating is uniform without any exposed iron areas.

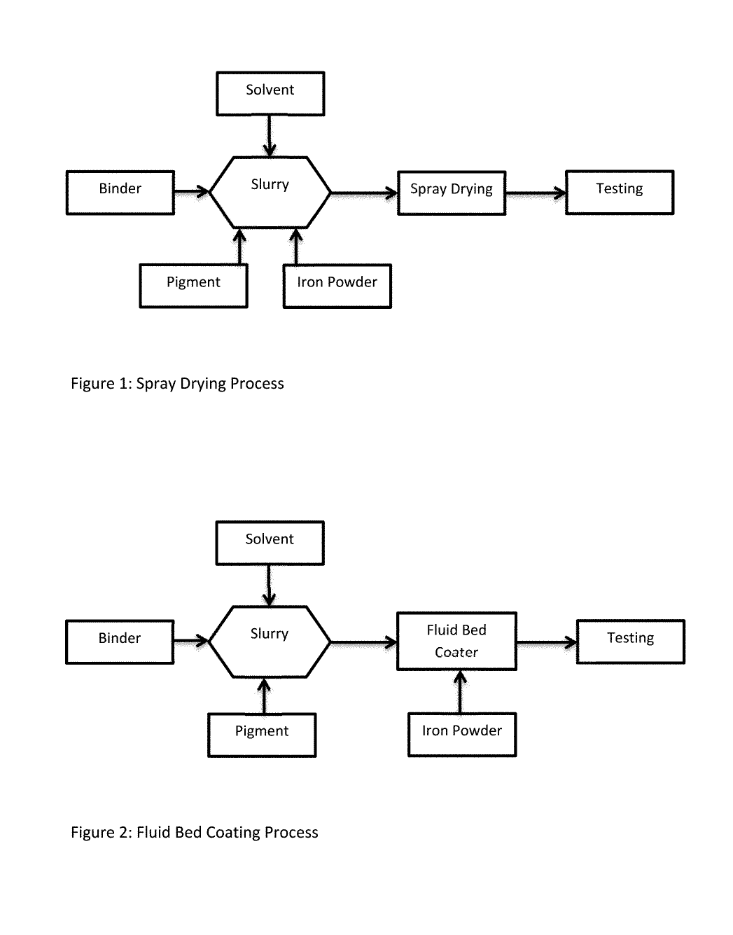

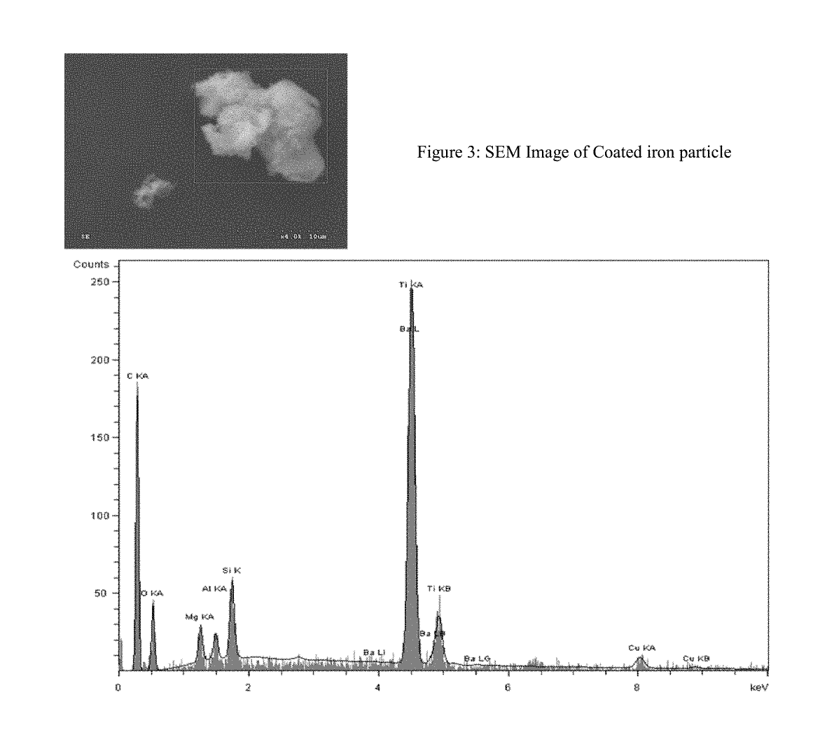

### DETAILED DESCRIPTION

Embodiments of the present specification are focused on iron fortification with a coated iron powder. An embodiment of the present specification is a coated iron powder, wherein the coated iron powder may be used as a food additive with high dissolution of the iron, such as a 40-45%. Available iron compounds may have an iron dissolution in the range 10-35%. Lynch et al., Int. J. Vitam. Nutr. Res., 77 (2), 2007 107-124 have shown the direct correlation between dissolution test and bioavailability of elemental iron in humans. Following is the accepted laboratory procedure to determine the solubility of iron: Dissolve 50 mg of elemental iron powder in 250 mL of an aqueous solution of 0.1N HCl solution (pH=1.0) at 37° C. (body temperature) and stir at 150 rpm. Take sample of the solution after 30 minutes, filter and analyze for iron content. This will give % of iron dissolved in the HCl solution.

RBV (Relative Bioavailability Value) is calculated with reference to FeSO₄ with dosage containing same level of Fe %. Solubility of H reduced iron in 0.1N HCl is 40-45%. This may be determined by adding 50 mg of iron powder to 250 mL of an aqueous solution of 0.1N HCl at 37° C., and stirring at 150 RPM for 30 minutes. A goal of certain embodiments of the present specification is to achieve same level of solubility with coated iron. One manner of achieving the same level of solubility is by selecting a coating material(s) that will rapidly dissolve in 0.1N HCl solution. Further, the coated iron powder may be masked, such that the coated iron powder may be surreptitiously added to light colored foods and taste additives such as rice, yogurt, milk, noodles and table salt.

Embodiments of the present specification are configured to withstand cooking and storing conditions without degradation or discoloration. For example, the bioavailability of the iron is preserved, without releasing color (e.g., oxidation coloring) in prepared food or onto storing and cooking vessels. Surprisingly, embodiments of the present specification have been able to synergistically provide a sufficiently high level of bioavailability of iron, while also providing an iron that does not oxidize during storage and/or food preparation.

Embodiments of the present specification relate to a coated iron powder that may be used as a food additive in rice, yoghurt, noodles and table salt. In embodiments, the coated iron powder will not absorb moisture from air in normal storing condition. In embodiments, the coated iron powder will not dissolve in water at room temperature, or even at boiling temperatures. In embodiments, the coated iron powder is stable at the pasteurization conditions of heating and cooling cycles between 70° C. and 4° C. for Milk and yoghurt applications. This enables use of the embodiments of the coated iron powder in all major food and taste sources. In embodiments, the coated iron powder ensures that no discoloration occurs due to the type of storage or type of cooking containers used.

Embodiments of the present specification relate to a coated iron powder, wherein iron particles are masked with a protective layer, preferably along with color pigment. Exemplary color pigments include TiO₂, which may mask the dark color of iron, allowing the coated iron powder to be surreptitiously blended in variety of white food types. For example, the coated iron powder may have an L value of about 80-95, preferably 86-94, and preferably 90-92. Whiteness is defined by L value of the reflection spectrum. Different foods will have different L values. L values for salt, rice, yoghurt, milk and noodles are in the range 80-95.

Embodiments of the present specification relate to methods of making a coated iron powder. For example, embodiments relate to the process of masking iron with coatings, e.g., FDA-approved coatings that will survive the cooking and storing conditions of foods. Further, embodiments of the coating dissolve during the digestive process, such as in gastric acid, so that the iron powder, e.g., free iron, is available for absorption by the body.

Embodiments of the present specification relate to coated iron powder that includes an adjuvant, such as a catalyst to increase the bioavailability of iron. Exemplary adjuvants include ascorbic acid, particularly L-Ascorbic acid and Folic acid.

Embodiments of the present specification relate to a coated iron powder, wherein the coated iron particle has iron content from 10-50%. Exemplary iron powder may be hydrogen reduced, electrolytic or carbonyl iron powder. A preferred form of iron powder is a food grade elemental iron, such as disclosed in U.S. Pat. No. 7,407,526 at column 4, Examples 1 and 2. The entire disclosure of U.S. Pat. No. 7,407,526 is hereby incorporated by reference in its entirety. Reduced and electrolytic iron is in proper ionic state to be readily soluble in digestive system. Further, the high surface area of reduced iron powder increases the solubility rate of iron.

For example, the precursor iron powder may be a reduced iron powder having irregularly shaped particles, wherein the iron powder has a ratio AD:PD less than 0.3, wherein AD is the apparent density in g/cm³ and wherein PD is the particle density in g/cm³. Additionally the specific surface area of the precursor powder particles should be above 300, preferably above 400 m²/kg as measured by the BET method, and the average particle size should be between 5 and 45, preferably between 5 and 25 microns.

In preparing the precursor iron powder, a natural hematite (Fe₂O₃) may be used as an iron oxide starting material. An alternative is to use the type of iron oxides which are obtained as by-products from acid regeneration processes. In order to obtain a product having the desired properties the particle size of the starting material should preferably not exceed 55 microns.

The reduction of the starting material may be performed with hydrogen gas or a mixture of carbon and hydrogen gas. Preferably, the reduction may be performed in a belt furnace at temperatures up to 1100° C. Preferably, the reduction is performed in such a way that the resulting product is in the form of a powder or a slightly sintered cake which can easily be milled without any impact or with only slight impact on the particle shape and other properties.

In an embodiment, the precursor iron powder may have a porous and irregular shape and consequently a low apparent density, AD; such as less than 2 g/cm³.

Furthermore, the pores of the precursor powder are preferably open, facilitating the penetration of the gastric juice into the iron particles giving a sufficient high dissolution rate of the iron. A low-degree of open porosity is manifested in a value of particle density close to the value of the true density of iron, which is about 7.86 g/cm³. Preferably, the relation between AD and PD should be less than 0.3.

As used herein the particle density, PD, is measured by using a pycnometer apparatus, which allows liquid to flow into open pores of the iron particles in a container of definite volume under controlled conditions. The particle density is defined as the particle mass divided by the particle volume, including the inside closed pores. As the liquid fluid was 5% of a 99.5% ethanol solution used. The weight of the pycnometer, the pycnometer including the iron powder sample, and the pycnometer including the iron powder sample filled with the penetration fluid up to the definite volume were measured. As the definite volume of the pycnometer and the density of the penetrating fluid is known the particle density can then be calculated.

The particle size of the precursor iron powder particles may also be a parameter influencing the dissolution rate. A too coarse particle size will negatively influence the dissolution rate and a too fine particle size of the iron powder increase the risk for dust explosions during handling. A sufficiently high dissolution rate may obtained when the average particle size of the precursor iron particle is between 5 and 45 microns, preferably between 5 and 25 microns.

Embodiments of the present specification rely on a synergy of iron in correct ionic state with high surface area to allow a minimum of additional adjuvants to achieve a sufficiently high level of bioavailability of iron, while also providing an iron that does not oxidize during storage and/or food preparation.

In an embodiment, iron powder is coated with a first coating to form a coated iron powder. The first coating may be an organic polymer, and may optionally include a pigment, such as TiO₂, talc, or a combination of TiO₂ and talc. Pigment, for example TiO₂, is preferably included in the first coating. To achieve the desired whiteness, multiple layers of a coating with pigment may be required. Thus, by including a pigment in the first coating, a thinner second coating and/or a second coating with less pigment may be used to achieve a desired level of whiteness. Additionally, fewer layers of the second coating may be needed to achieve a desired level of whiteness. The first coating may also optionally include an anti-tacking agent, such as talc, and optionally include a plasticizing agent, such as DBS (Dibutyl Sebacate).

The coated iron powder is then treated with at least one adjuvant, such as ascorbic acid. The first coating between the iron powder and the adjuvant prevents the adjuvant from reacting with the iron powder prior to human consumption.

This adjuvant-treated, coated iron powder is then coated with a second coating to form a twice-coated iron powder. The second coating may be the same as the first coating, or may be different. The second coating may be an organic polymer. The second coating preferably includes a pigment, such as TiO₂. The second coating may also optionally include an anti-tacking agent, such as talc, and optionally include a plasticizing agent, such as DBS (Dibutyl Sebacate). The pigment preferably allows the twice-coated iron powder to achieve desired whiteness to be blended with a light-colored food, such as rice, noodles, or yogurt and not be readily discernible. To achieve the desired whiteness, multiple layers of the second coating may be required. For example, the second coating may be applied a total of 1 time, 2 times, 3-5 times, or more.

The iron powder is preferably a food-grade elemental iron, preferably reduced or electrolytic iron. Reduced iron power has a sponge like morphology and electrolytic iron has dendritic morphology. Both of these types provide a high surface area which is helpful in rapid dissolution of such particles in human digestive system. Reduced and electrolytic irons are in the proper ionic state in order to be readily soluble in a human's digestive system. Further, ascorbic acid can be added to the coated iron powder to accelerate iron absorption in human digestion system. This allows a reduction in the amount of coated iron powder that is blended with a food product, while maintaining or increasing the amount of iron absorbed.

The precursor iron powder preferably has a size D₅₀ of less than 53 microns, preferably in the range of 10-53 microns, preferably 15-53 microns, preferably 15-25 microns. In embodiments, the size D₅₀ is less than 20 microns, measured by a particle size analyzer—uses laser to measure particle size (Sympatec HELOS/BF).

The coated iron particle preferably has iron content from 10-50 wt %, preferably 20-50 wt %, 30-40 wt %, based on the total weight of the coated iron particles. Including less iron content may cause reduced bioavailability and increased amounts of coating material. Including more iron content may mean there is too little coating to be a viable powder.

The first and second coatings preferably survive exposure to moisture or water and cooking, and only dissolve upon human (or animal) consumption, e.g., exposure to gastric acid. Exemplary coatings include water soluble and water insoluble polymers which are known to form uniform non-tacky films. Generic examples of these polymers include hydroxypropylmethylcellulose (HPMC), dimethylaminoethyl methacrylate, a copolymer based on dimethylaminoethyl methacrylate, butyl methacrylate, and methyl methacrylate, e.g., Eudragit® E100, E12.5, E PO, Opadry® NS, PVP (polyvinyl pyrrolidone), such as PVP k90 and PVP k30, dichloromethane (DCM). A preferred first coating is HPMC, applied in an aqueous solvent, and preferred second coating is dimethylaminoethyl methacrylate based coating, applied in a non-aqueous solvent, for example, ethanol, dichloromethane, isopropyl alcohol, etc. Preferably, the first and second coatings are configured to dissolve in gastric acid in less than 600 seconds, preferably less than 60 seconds, preferably less than 10 seconds. This may be measure by visual observation of the powder coating separation in 0.1N HCl at 150 RPM stirring, from adding 50 mg of powder to 250 mL of the HCL solution at 37° C. The second coating preferably is applied with a different solvent than that used in the first coating. If the same solvent is used for both coatings, there is risk that the application of the second coating would dissolve the first coating.

The first coating is preferably coated to a thickness of 5 to 30 microns, more preferably 5 to 25 microns, or 8 to 15 microns. It has been discovered that a coating of 8 to 16 microns provides effective protection while also dissolving reasonably quickly in the human digestive tract. A coating of a thickness of less than 5 microns may not be effective due to adjuvant, such as ascorbic acid, leaching through and reacting with the iron powder prior to human consumption. A coating of a thickness of greater than 30 microns may be difficult to apply and may unreasonably slow the dissolution in the human digestive tract. If a pigment, such as TiO₂, is included in the first coating, the pigment is preferably included in an amount of 5 to 50 wt %, preferably 10 to 40 wt % with regard to the total weight of the first coating. Surprisingly, the inclusion of the pigment in the first coating acts to allow a thinner second coating and/or a second coating with less TiO₂. For example, if pigment is included in the first coating, the black color of the iron particle is sufficiently diluted such that the amount of pigment in the second coating can be adjusted to achieve various levels of whiteness. This allows easier product control.

The second coating is preferably coated to a thickness of 5 to 30 microns, more preferably 5 to 25 microns, or 8 to 15 microns. It has been discovered that a coating of 8 to 16 microns provides effective protection while also dissolving reasonably quickly in the human digestive tract. The double coating may, according to this, be between 10-30 microns thick. A coating of a thickness of less than 5 microns may not be effective due small pores or gaps forming at such thin levels of coating. This can allow water to pass through and react with and/or wash away the adjuvant, e.g., ascorbic acid, prior to human consumption. A coating of a thickness of greater than 30 microns may be difficult to apply and may unreasonably slow the dissolution in the human digestive tract. If a pigment, such as TiO₂, is included in the second coating, the pigment is preferably included in an amount of 5 to 50 wt %, preferably 10 to 40 wt % with regard to the total weight of the second coating.

An adjuvant is preferably at least ascorbic acid. In an embodiment, ascorbic acid is known to improve iron metabolism thereby increasing iron dissolution and bioavailability. In an embodiment, ascorbic acid may be combined with folic acid. Folic acid may be included in amounts from 1 to 10% of total coating weight. Ascorbic acid is preferably added to the single coated iron powder by dipping particles in an aqueous ascorbic acid solution and drying, spray coating on the particles, or a fluid bed coating on the particles. The coating of ascorbic acid is preferably at a thickness of less than 1 micron, more preferably less than 500 nm, or less than 300 nm. The coating of ascorbic acid may not be uniform or a complete coating of the underlying iron powder.

The first coating, adjuvant coating, and second coating may be applied by a primarily mechanical bonding process, as opposed to complex and essentially chemical bonding processes previously used. It may be preferred to use mechanical bonding instead of chemical bonding typically used industry-wide for food fortification. Mechanical bonding is sufficiently strong enough to withstand the general handling conditions including food preparation conditions. At the same time mechanical bonding is easier to break with chemical reaction. This can be achieved by selecting the appropriate materials for coating that would withstand the ‘inert’ conditions but are very much less resistant to ‘acidic’ conditions as in the gastric fluids. We have made use of this property by selecting appropriate materials to protect iron before consumption, while making it quickly available for absorption after consumption.

In an embodiment, the coated iron powder is able to withstand boiling in water at 100-121° C. at 1-2 atm for a period of at least 10 minutes, preferably at least 20 minutes, at least 30 minutes or at least 45 minutes without showing any signs of degradation. Degradation may be shown by a rusty ‘iron oxide’ color leaching into the food. Further, degradation may be shown by determining if any ascorbic acid leached to the water.

In an embodiment, the coated iron powder is able to withstand pasteurization with heating and cooling cycles between 70° C. and 4° C. for a period of at least 20 minutes, preferably at least 10 minutes, without showing any signs of degradation. Degradation may be shown by a rusty ‘iron oxide’ color leaching into the food. Further, degradation may be shown by determining if any ascorbic acid leached to the water.

In an embodiment, the coated iron powder is able to withstand exposure to a humid environment (i.e., a relative humidity of 60% at a temperature of 25° C.) for a period of at least 100 days, preferably at least 300 days, without showing any signs of degradation. Degradation may be shown by a rusty ‘iron oxide’ color leaching into the food. Further, degradation may be shown by determining if any ascorbic acid leached to the water.

In an embodiment, the coated iron powder should be configured to be blended with foods with no sensory (color, appearance, odor or taste) changes, even after cooking of the foods. For stability in cooking conditions, the powder can be boiled in water for 45 minutes. A stable coated iron powder should not break during the boiling. This may be determined by the water color. If the water color changed to cloudy or white, this is indication of coating breaking and dispersing in the water. Additionally if the coating breaks right away, water may also turn brownish due to oxidation of bare iron in the water.

In embodiments, the coated iron powder is configured such that no discoloration occurs due to the type of storage or cooking containers are used.

A preferred embodiment may comprise, consist essentially of, or consist of:
Elemental Iron (e.g., Hydrogen Reduced Iron and Electrolytic Iron):
   This highly porous product may have an irregular morphology with particle size distribution of D₁₀=13 μm, D₅₀=26 μm and D₁₀₀=55 μm. Average Surface area and average apparent density of Nutrafine are 0.2461 m²/g and 2 g/cm³, respectively;
A First Coating:
   Water soluble and water insoluble polymers which are known to form uniform non-tacky films can be used for coating process. Generic examples of these polymers include hydroxypropylmethylcellulose (HPMC) Methocel E5 Low Viscosity and Eudragit E100. The first coating may optionally include a pigment;
Adjuvant Coating:
   Ascorbic Acid may be used as a catalyst to accelerate iron absorption; and
A Second Coating with Pigment (Masking Color):
   Water soluble and water insoluble polymers which are known to form uniform non-tacky films can be used for coating process. Generic examples of these polymers include hydroxypropylmethylcellulose (HPMC) Methocel E5 Low Viscosity and Eudragit E100. The second coating may optionally include a pigment. Titanium dioxide may be used as a white pigment. Various concentrations of titanium dioxide in coating solution can be used to obtain uniform and white coating that masks the black color of iron powder.

The first and second coatings may be applied by dissolving the coating material in a solvent. The solvent used should be able to dissolve the coating material (e.g., a polymer binder). Preferred examples of the solvent include water or ethanol.

Surprisingly, embodiments of the present specification may be more bioavailable than an uncoated iron powder, even if the iron powder is hydrogen reduced iron or electrolytic iron. It is suspected that a thin oxide film on bare elemental iron powder may be responsible for the delayed release of iron. In contrast, elemental iron used to form coated iron according to embodiments of the specification may be free of the oxide film (e.g., due to processing and forming the coatings).

1. A coated iron powder comprising:
a core of precursor iron powder, wherein the iron powder is reduced or electrolytic iron powder;
a first coating comprising a first polymer and a first pigment, wherein the coating has a thickness of thickness of 5 to 30 μm;
an application of an adjuvant, wherein the adjuvant comprises ascorbic acid;
a second coating comprising a second polymer and a second pigment, wherein the coating has a thickness of thickness of 5 to 30 μm.

2. The coated iron powder of claim 1, wherein the first pigment and the second pigment comprise TiO₂.

3. The coated iron powder of claim 1, wherein the first coating prevents the adjuvant from reacting with the iron powder prior to human consumption.

4. The coated iron powder of claim 1, wherein the first polymer and the second polymer are the same.

5. The coated iron powder of claim 1, wherein the first polymer and the second polymer are different.

6. The coated iron powder of claim 1, wherein the first polymer is configured for application with an aqueous solvent, and the second polymer is configured for application with a non-aqueous solvent.

7. The coated iron powder of claim 1, wherein the first polymer comprises hydroxypropylmethylcellulose.

8. The coated iron powder of claim 1, wherein the second polymer comprises dimethylaminoethyl methacrylate.

9. The coated iron powder of claim 1, wherein the precursor iron powder has a size D50 of 10-53 microns.

10. The coated iron powder of claim 1, wherein the coated iron particle has iron content from 10-50 wt %, based on the total weight of the coated iron particles.

11. The coated iron powder of claim 1, wherein a combination of the first coating, the adjuvant coating, and the second coating is configured to dissolve in gastric acid in less than 600 seconds.

12. The coated iron powder of claim 1, wherein the second coating is configured to dissolve in gastric acid in less than 600 seconds.

13. The coated iron powder of claim 1, wherein the first pigment is included in an amount of 5 to 50 wt %, with regard to the total weight of the first coating.

14. The coated iron powder of claim 1, wherein the second pigment is included in an amount of 5 to 50 wt %, with regard to the total weight of the second coating.

15. The coated iron powder of claim 1, wherein the application of adjuvant has a thickness of less than 1 μm.

16. The coated iron powder of claim 1, wherein the coated iron powder is configured to withstand boiling in water at 100-121° C. at 1-2 atm for a period of at least 10 minutes, preferably at least 20 minutes, at least 30 minutes or at least 45 minutes without showing any signs of degradation.

17. The coated iron powder of claim 1, wherein the coated iron powder is configured to withstand pasteurization with heating and cooling cycles between 70° C. and 4° C. for a period of at least 20 minutes, without showing any signs of degradation.

18. The coated iron powder of claim 1, wherein the coated iron powder is configured to withstand exposure to a relative humidity of 60% at a temperature of 25° C. for a period of at least 100 days, without showing any signs of degradation.

19. The coated iron powder of claim 1, wherein the precursor iron powder has a particle size distribution (D10) in the range of 10 to 20 μm, a particle size distribution (D50) in the range of 15 to 30 μm, and a particle size distribution (D90) in the range of 40 to 70 μm.

20. The coated iron powder of claim 1, wherein the precursor iron powder has an average surface area in the range of 0.2 to 0.5 m2/g and average apparent density of 0.8 to 3 g/cm3.
